(19) United States
(12) Patent Application Publication
(10) Pub. No.: US 2010/0001662 A1
(43) Pub. Date: Jan. 7, 2010

(54) LED CANDELABRA FIXTURE AND LAMP

(76) Inventors: Allan R. NELKIN, Atlanta, GA (US); David R. NELKIN, Atlanta, GA (US); Austin A. GELDER, Acworth, GA (US); Kim B. COOK, Cumming, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/496,957

(22) Filed: Jul. 2, 2009

Related U.S. Application Data
(63) Continuation-in-part of application No. 12/392,597, filed on Feb. 25, 2009.
(60) Provisional application No. 61/031,944, filed on Feb. 27, 2008.

(51) Int. Cl. H05B 37/02; F21V 35/00; H05B 41/36; F21V 9/00

(52) U.S. Cl. 315/294; 362/392; 315/291; 362/231

(57) ABSTRACT

An electric lighting lamp or bulb having an LED light source mounted to a candle base, and wherein driver circuitry for the LED light source is housed within the candle base. A transparent envelope encloses the LED light source, and the lamp presents the appearance of a traditional candle and/or of an incandescent candelabra or chandelier-type lamp or bulb.

### CROSS-REFERENCE TO RELATED APPLICATION

This application is a continuation-in-part of U.S. Non-Provisional patent application Ser. No. 12/392,597, filed Feb. 25, 2009, which claims the benefit of U.S. Provisional Patent Application Ser. No. 61/031,944, filed Feb. 27, 2008, the entireties of which are hereby incorporated herein by reference.

### TECHNICAL FIELD

The present invention relates generally to electric lighting, and more particularly to an LED candelabra or chandelier-type lamp or light bulb, and a fixture for receiving one or more such lamps.

### BACKGROUND OF THE INVENTION

Traditional incandescent lamps or light bulbs have been found to suffer from a variety of shortcomings, including inefficient use of energy and limited lifespan. Other types of lamps, such as compact fluorescent lamps (CFLs) and light emitting diode (LED) lighting are taking the place of incandescent lamps in certain applications. These newer forms of lighting, however, often present their own challenges. For example, challenges related to LED lighting applications include the dissipation of heat, and the space requirements of electronic driver circuitry for LED lights.

Thus it can be seen that needs exist for continuing improvements to lighting components, fixtures and systems. It is to the provision of an improved lamp, and to lighting fixtures, systems and methods related thereto, meeting these and other needs that the present invention is primarily directed.

### SUMMARY OF THE INVENTION

In example forms, the present invention is an LED lamp for use in connection with candelabra and/or chandelier type lighting fixtures. In one aspect, the lamp of the present invention includes an LED light source, a candle base housing the electronic driver circuitry for the LED light source, and a transparent or light-transmissive envelope affixed to the candle base and surrounding the LED light source.

In another aspect, the invention is chandelier or candelabra light fixture comprising one or more sockets for receiving an LED lamp as described above.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 shows an LED candelabra-type lamp or bulb, and a portion of a fixture for receiving such a lamp or bulb, according to example forms of the present invention.

FIG. 2 shows a chandelier-type lighting fixture incorporating a plurality of LED candelabra lamps according to another example form of the present invention.

FIG. 3 shows a cross sectional view of an embodiment of an LED subassembly according to an example form of the present invention.

FIG. 4 shows an isolated embodiment of a candle tube for use with the LED Assembly in FIG. 3.

FIG. 5 shows an isolated embodiment of a base for use with the LED Assembly in FIG. 3 and the candle tube in FIG. 4.

FIG. 6 shows an isolated embodiment of a decorative envelope for use with the LED assembly in FIG. 3.

FIG. 7 shows a side view of an example embodiment of an optic and LED assembly.

FIG. 8 shows a top planar view of the embodiment in FIG. 7.

FIG. 9 shows an alternate embodiment of an optic and LED assembly.

FIGS. 10-13 show an assembly sequence for a lamp according to an example form of the invention.

FIG. 14 shows example alternate embodiments of lamp bases for use in connection with a lamp according to example forms of the invention.

FIG. 15 shows example alternate embodiments of decorative envelopes for use in connection with a lamp according to example forms of the invention.

FIG. 16 shows a wall sconce fixture embodiment incorporating lamps according to an example form of the invention.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

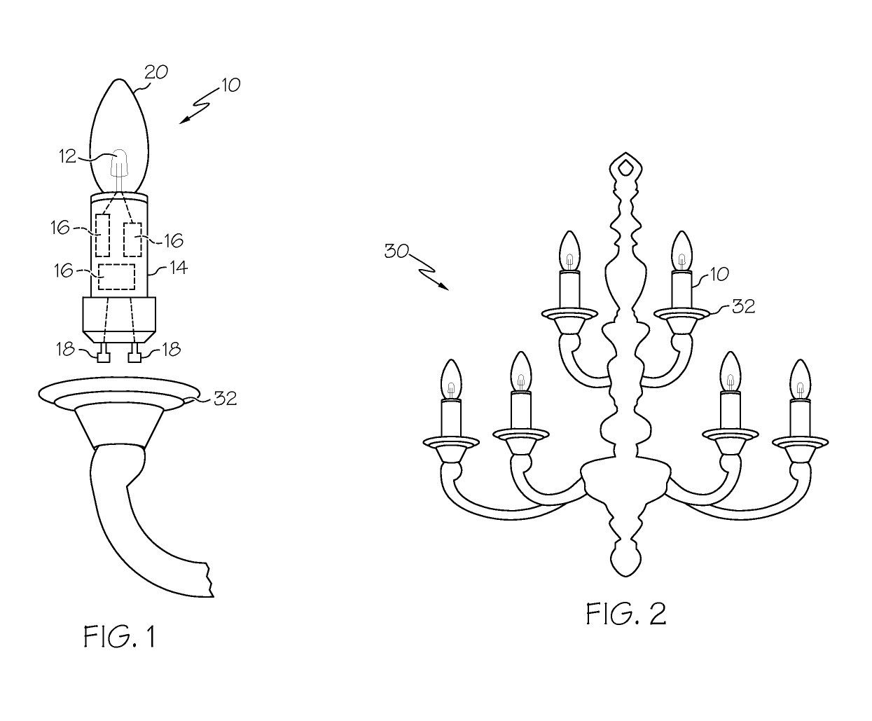

With reference now to the drawing figures, FIG. 1 shows an LED lamp or bulb 10 according to an example form of the present invention. The lamp 10 includes a light emitting diode (LED) light source 12. The LED 12 may take the form of any of a variety of LEDs of various wattages, designs, Kelvin temperatures, colors, multicolor packages, light output color, and/or various other design characteristics. The term LED, when used herein, can refer to a single LED diode, a mounted single LED, a multi-chip LED package, or an LED array of multiple LEDs incorporated into a single package with or without a primary optic. The lamp 10 further comprises a candle base 14, housing internal driver circuitry components 16 for powering the LED 12. The candle base 14 further includes two or more electronic contacts 18 extending from its lower end for delivering electricity to the driver circuitry components 16. A transparent, translucent or otherwise light transmitting envelope 20 of glass, plastic, or other material preferably surrounds the LED 12, and is affixed at an upper end of the candle base 14. In the depicted embodiments, the candle base 14 is generally cylindrical, having a diameter and a height of at least one to two times the diameter, and has a white, cream, beige, or other exterior color; and the transparent envelope 20 is preferably tapered to a point at its distal end, whereby the lamp 10 generally presents the appearance of a candle and/or of a traditional incandescent candelabra or chandelier-type lamp. In other embodiments, candle bases of differing geometry and/or appearance are provided, for example geometric prism shapes (a three dimensional polyhedron with a polygon such as a square or a octagon as a face and rectangles as sides), spherical candles, tapered cylindrical candles, any of the above referenced shapes altered to create the appearance of wax melted by the heat of a candle flame, any of the above referenced shapes with decorative “fluting” or grooves, or any of the above referenced shapes contained in glass to give the appearance of a candle contained in a votive or other light transmitting vessel.

In example forms, the candle base 14 of the lamp 10 comprises a small electrical contact base, comprising the contacts 18 and having a size and shape compatible with any of various standard lighting fixture connections, such as E12, GU10, Ba15 contact configurations. As seen in FIG. 2, one or more lamps 10 according to the present invention may be used in connection with a light fixture 30, such as a chandelier, wall sconce, post light, outdoor lantern or the like, which commonly utilize candelabra or chandelier-type lamps having the appearance of traditional candles. In example forms, the candle base 14 sits in a cup-shaped member 32 that is part of the fixture 30, or alternatively may be part of the lamp 10. The fixture optionally includes a socket or contact points that are recessed in the cup 32 for removably receiving a portion of each lamp base and its electrical contacts. The candle base 14 and/or the cup-shaped member 32 of the fixture optionally comprise one or more fins or heat sink members formed of metal or other heat-transmissive materials, to assist in dissipating heat from the LED 12 and/or from the driver circuitry components 16.

The invention further includes a light fixture 30 for receiving and delivering energy to one or more lamps 10 as described. The fixture includes at least one socket configured to receive the candle base 14 of the lamp(s). In the depicted embodiment, the fixture is a multi-lamp, hanging chandelier type of fixture, but the invention also includes fixtures including wall-mounted, floor or table-standing lamp, hanging, single or multi-bulb, sconce, pendant, or other lighting furniture and other fixture types. The at least one socket of the fixture preferably includes two or more electronic terminals or contacts for delivering electrical energy to corresponding contacts of the lamp(s). Optionally, the LED driver circuitry components are housed in the fixture, rather than the lamp bases. The fixture preferably further comprises one or more wires or other conduits for delivering electricity from a remote source to the lamps, and optionally comprises a switch, sensor or other control means for turning the light on and off, and/or for adjusting the intensity of the light delivered. The fixture optionally also may include one or more diffusers or shades for assisting in distributing or focusing the light output.

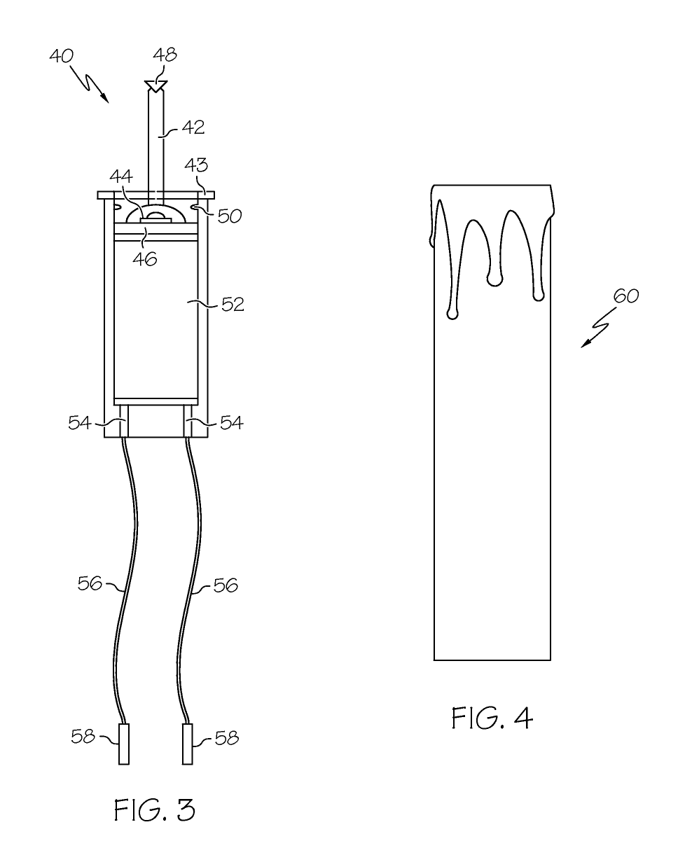

An example LED subassembly 40 is shown in FIG. 3. The LED assembly 40 converts power from the incoming voltage and current into a voltage and current appropriate for an LED, and transports the light to the appropriate location within a decorative envelope. As shown, an LED emitter 46 contains an LED package 44 with a primary optic. The LED emitter 46 projects light upwardly through a light transporter 42 toward a secondary optic 48. This process can be completed by a variety of methods used to move the light from an LED to an appropriate Light Center Length in an envelope. The example LED assembly 40 has retainers 50 for the threading of decorative envelopes described below or other facilitating method of securing the envelope to the LED assembly 40. An LED driver 52 converts incoming voltage and current into the appropriate characteristics for operating the LED package 44. Input terminals 54 are secured to the LED driver 52 to introduce power into the LED driver 52. Wire leads 56 carry power to the input terminals 54. Connectors 58 electrically connect the wire leads 56 to a base such as base 14 in FIG. 1.

The LED assembly 40 is placed into a candle tube 60 as shown in FIG. 4. The candle tube 60 can be a metal, ceramic or plastic shell, or can be formed of other materials, and can be a variety of colors, sizes and shapes. The candle tube 60 has an open top and bottom and a hollow center. The LED assembly 40 may produce a large amount of heat and the candle tube 60 releases heat produced by the LED assembly 40. The candle tube 60 releases heat through radiation, convection or conduction, and optionally includes fluting, ridges, fins, projections, recesses or other surface features to increase surface area and enhance heat dissipation therefrom. In example form, the projecting surface features can take the form of simulated wax dripping down the side of the simulated candle body. The LED assembly 40 is placed in the candle tube 60 ensuring the wire leads 56 go in first and hang out from the bottom of the candle tube 60. A rim 43 of the LED assembly 40 (shown in FIG. 3) ensures proper placement within the candle tube 60, and friction, compression, a retaining ring, gasket, connector, coupling, adhesive, or other means of attachment secures the LED assembly 40 within the candle tube 60.

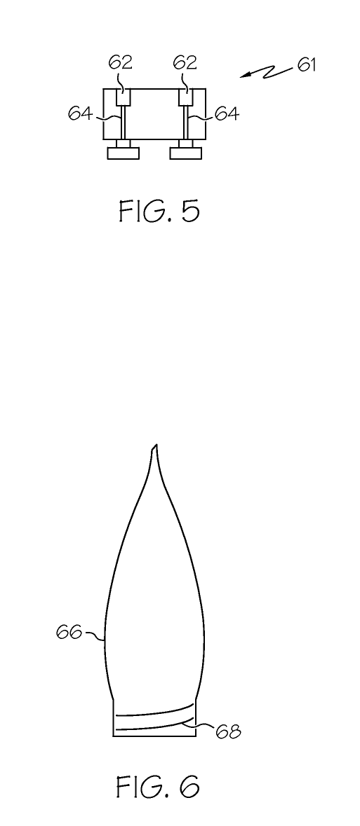

As shown in FIG. 5, the base 61 secures to the bottom of the candle tube 60. The base 61 can fit around the candle tube 60 or insert into the bottom of the candle tube 60 using friction, adhesive, notching/threading or other like method of securing. The excess wiring 56 is pushed up into the candle the 60. The base 61 has terminals 62 which receive the connectors 58 attached to the wire leads 56. There are connections 64 between the terminals 62 and the base 61. The connections 64 can be GU-10, but alternatively can be any base type such as E11, E12, E14, E26, E27, BA15D, or any other like base.

An example of a decorative envelope 66 is shown in FIG. 6. The decorative envelope 66 has an open bottom that is placed over the LED optic 42 (FIG. 3) and secured to the LED assembly 40 using friction or adhesive, notching/threading or other like method of securing. The envelope 66 alternatively has threads 68 which screw onto the retainers 50 in the LED subassembly. The decorative envelope is translucent, transparent, or otherwise light-transmissive.

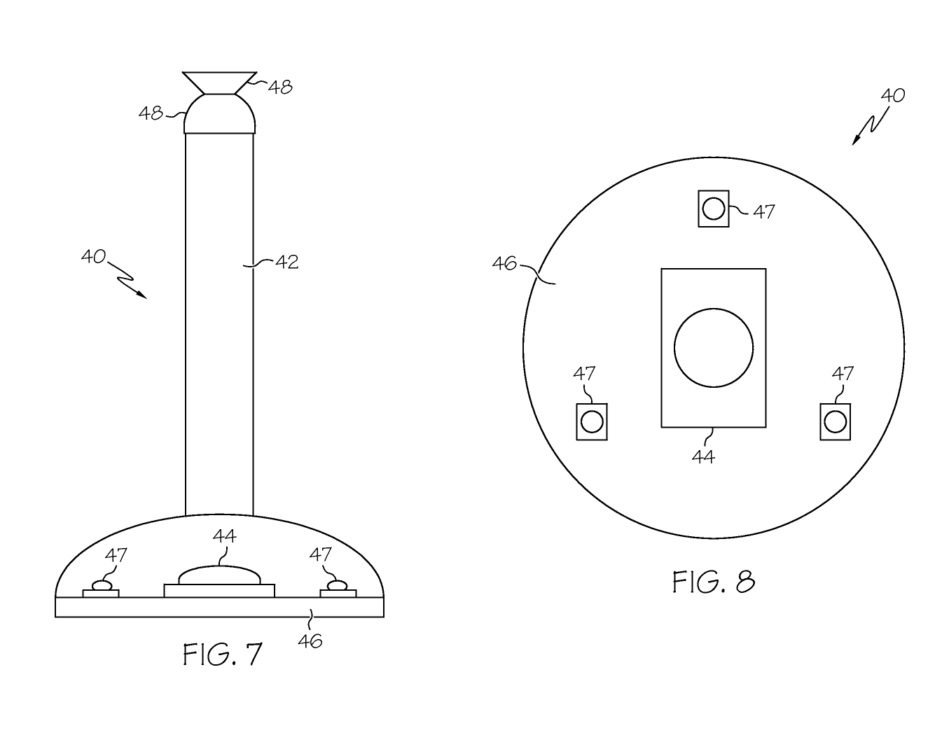

FIGS. 7 and 8 shows an alternate embodiment of an LED assembly 40, according to the present invention. The LED assembly 40 has at least one high power LED package 44 and at least one low power color surface mount diode (SMD) package 47. In the depicted embodiment, three low power color SMD secondary LED packages 47 are arranged in triangular form about a single high power LED package. Optionally, the low power color SMDs are spaced at equal distances from one another around a centrally-located high power LED package. The primary LED package 44 emits a higher-intensity light of a first color (for example white light), and the secondary LED package(s) emit(s) a lower intensity light of one or more different colors (for example, yellow, red, orange, and/or blue). The lower intensity secondary light of different colors blends with the primary light to produce a light having desired color, brightness or other characteristics. For example, a white primary light may be provided for brightness, and secondary light of yellow, red, orange, and/or blue blended with the primary light to produce a light source having the color of a natural candle flame. Optionally, the secondary and/or primary LED packages are flickered on and off, and/or their relative intensities are varied, in a controlled manner, to produce a flickering effect similar to that of a real candle flame. One or more electronic controllers, microprocessors, or the like are optionally included for controlling the operation of the secondary and/or primary LED packages.

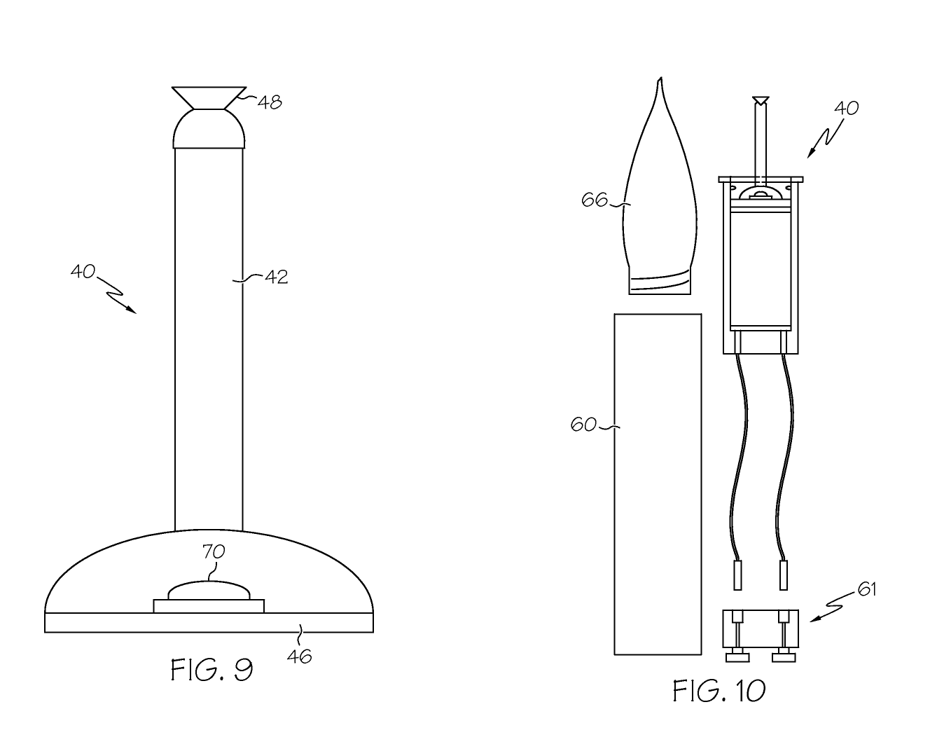

FIG. 9 shows another embodiment of an LED assembly 40, having a single LED package with a primary optic 70. The assembly 40 includes a light transporter 42 for transporting light to a secondary optic 48, and a PCB board or other form of control circuitry 46. The LED assembly 40 can operate independently or in tandem with one or more additional LED assemblies or other light sources. Onboard or remote control circuitry is optionally provided for generating a flickering effect or other desired light properties.

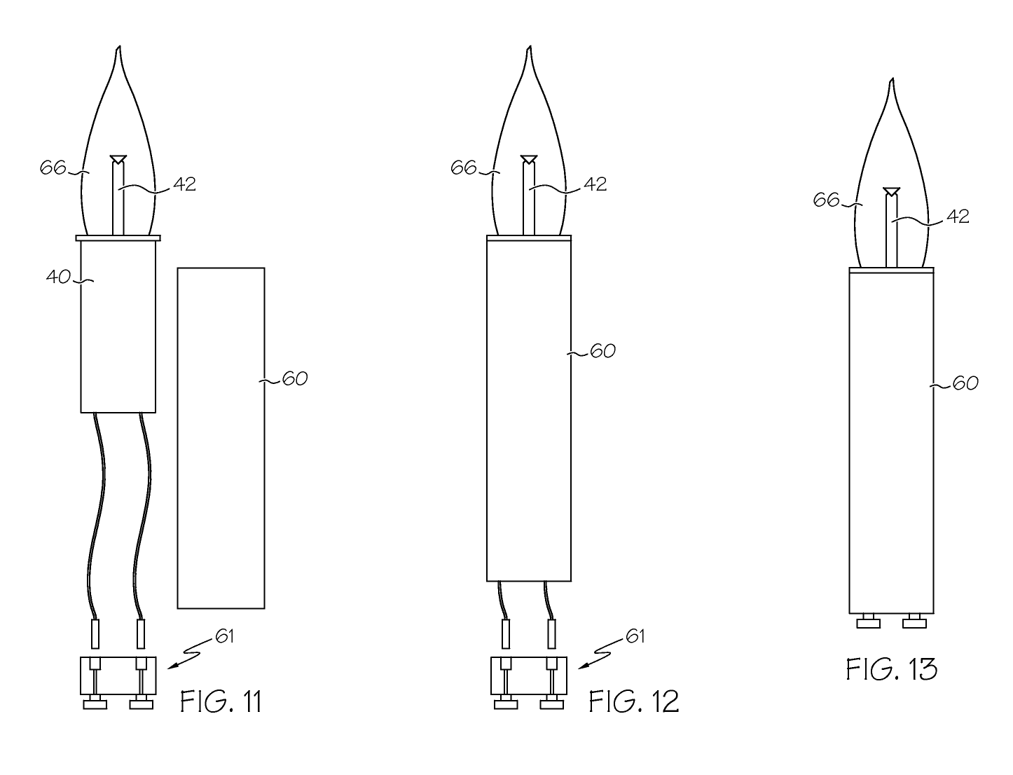

FIG. 10 shows an assembly view of the envelope 66, candle tube 60, LED assembly 40 and base 61 separated from each other. FIGS. 11-13 show an assembly sequence. FIG. 11 shows the envelope 66 inserted and secured within the LED assembly 40. FIG. 12 shows the LED assembly 40 inserted and secured within the candle tube 60 with the wire leads 56 and connectors 58 extending out of the bottom of the candle tube 60. FIG. 13 shows the base 61 inserted and secured into the bottom of the candle tube 60. The assembly can be is disassembled by reversing the stages described in FIG. 10-13. As used herein, an LED assembly includes at least one LED, and optionally includes driver, light transporter, heat transfer, electrical coupling, housing, and/or other associated components.

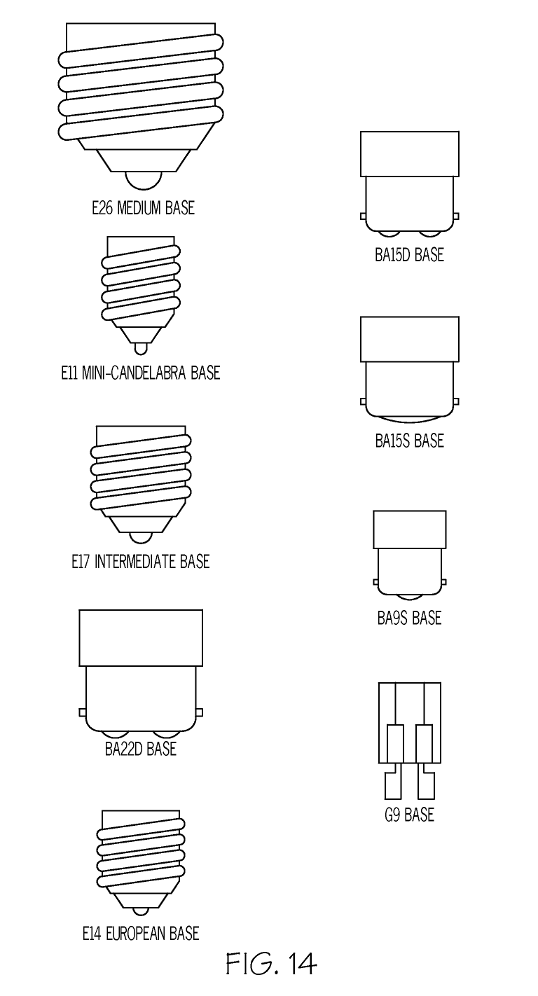

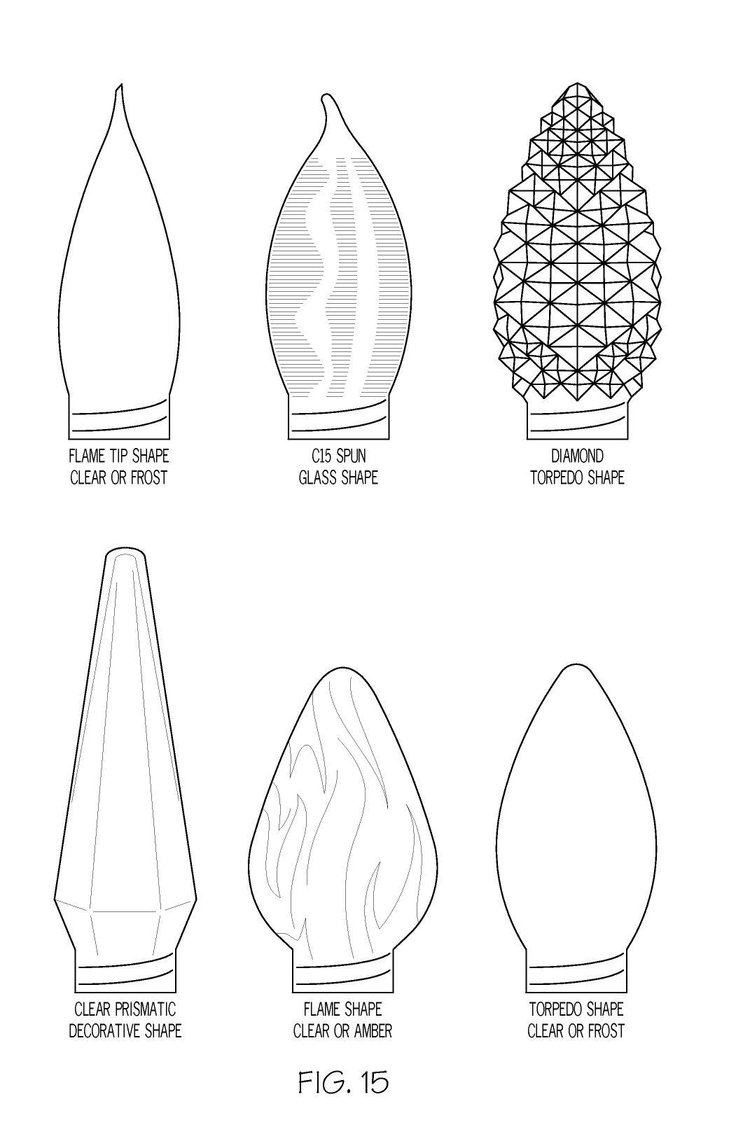

FIG. 14 shows a variety of optional base configurations that can be used as the base 61 of the LED lamp. Examples shown are the E26, E12, E11, E17, BA22D, E14, BA15D, BA15S, BA9S, GU10 and G9 base formats. FIG. 15 shows a variety of optional envelope configurations 66 suitable for use in connection with the lamp of the present invention, although other envelope configurations are within the scope of the invention. Examples shown are the flame tip (clear or frost), C15 spun glass shape, diamond torpedo shape, clear prismatic decorative shape, flame shape (clear or amber) or torpedo shape (clear or frost). Additionally, candle tubes of different lengths, diameters, and/or colors can be provided as optional off-the-shelf components. The provision of different bases and/or envelopes that are compatible with different candle tubes in a universal fit manner allows a supplier, distributor, service technician or end user to customize the lamp by assembling selected components into a desired combination.

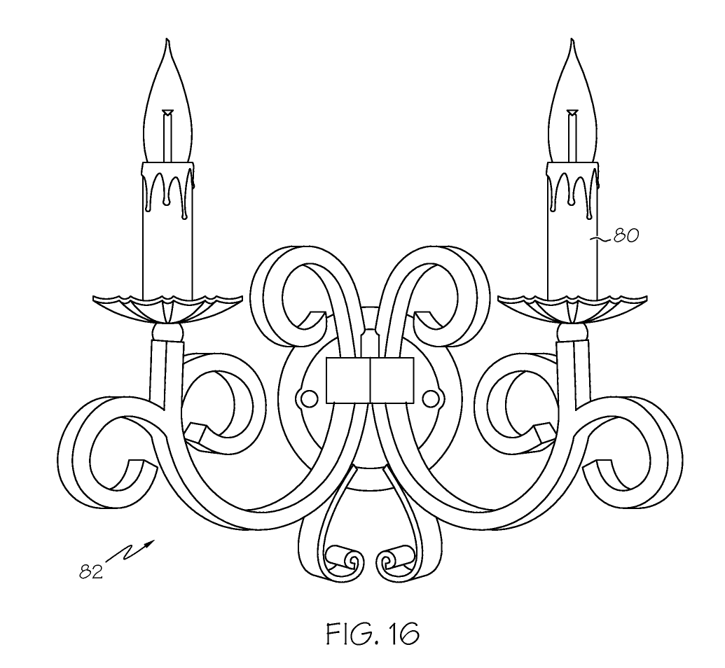

FIG. 16 shows an alternate embodiment of a lighting fixture 82, in the form of a wall sconce 82, including one or more lamps 80, as described herein. Optionally, the lamps 80 are removably affixed within a socket or other coupling of the fixture or permanently affixed to the body of the fixture 82. Additionally, the body of the fixture 82 can be in thermally conductive contact with the driver circuitry of the lamp, to allow heat from the driver circuitry to dissipate through and from the fixture body, effectively using the surface area of at least a portion of the fixture body as a radiator to cool the lamp.

While the invention has been described with reference to preferred and example embodiments, it will be understood by those skilled in the art that a variety of modifications, additions and deletions are within the scope of the invention, as defined by the following claims.

What is claimed is:

1. An electric lighting lamp comprising:
an LED assembly;
a candle tube, wherein the LED assembly fits within the candle tube;
a base, wherein the base connects electrically to the LED assembly and secures to the candle tube; and
an envelope, wherein the envelope secures over the LED assembly.

2. The electric lighting lamp of claim 1, wherein the LED assembly comprises an LED package, a secondary optic, and a light transporter transmitting light from the LED package to the secondary optic.

3. The electric lighting lamp of claim 1, wherein the LED assembly comprises an LED driver contained within the candle tube.

4. The electric lighting lamp of claim 3, wherein the candle tube dissipates heat from the LED driver.

5. The electric lighting lamp of claim 1, wherein the envelope is interchangeable.

6. The electric lighting lamp of claim 1, wherein the base electrically connects to the LED assembly through wire leads.

7. The electric lighting lamp of claim 1, wherein the LED assembly comprises an LED driver for converting incoming voltage and current.

8. The electric lighting lamp of claim 1, wherein the LED assembly comprises a high power LED package.

9. The electric lighting lamp of claim 1, wherein the LED assembly comprises a high power LED package and at least one low power SMD package.

10. The electric lighting lamp of claim 9, wherein the high power LED package and the at least one low power SMD package emit light of different colors.

11. The electric lighting lamp of claim 9, wherein at least one of the high power LED package and the at least one low power SMD package are controlled to flicker.

12. A lighting fixture comprising a fixture body, at least one LED lamp comprising an LED emitter, and driver circuitry for the LED emitter, and wherein at least one of the fixture body and the LED lamp dissipate heat from the driver circuitry.

13. The lighting fixture of claim 12, wherein the at least one LED lamp further comprises a candle tube housing the LED emitter therein.

14. The lighting fixture of claim 13, further comprising a socket for coupling with a base affixed to the candle tube of the LED lamp.

15. The lighting fixture of claim 12, wherein the at least one LED lamp comprises a secondary optic and a light transporter transporting light from the LED emitter to the secondary optic.

16. The lighting fixture of claim 12, wherein the at least one LED lamp comprises a high intensity LED package and at least one low intensity light source.

17. The lighting fixture of claim 16, wherein the high intensity LED package and the at least one low intensity light source are controlled to create the appearance of a candle flame.

18. An LED light source comprising:
a high-output LED light source emitting light of a first color;
at least one low intensity LED light source emitting light of a second color different from the first color;
a secondary optic; and
a light transporter for delivering light from the high-output LED light source and the at least one low intensity LED light source, to the secondary optic.

19. The LED light source of claim 18, wherein the first color is white.

20. The LED light source of claim 18, comprising three low intensity LED light sources arranged in triangular form about the high-output LED light source.

21. The LED light source of claim 18, wherein the high-output LED light source and the at least one low intensity LED light source are controlled to generate light presenting the appearance of a candle flame.

22. An assembly method for fabricating an electric lighting lamp, comprising:
installing an LED lighting assembly comprising an LED emitter, driver circuitry, and power leads into a candle tube to form a subassembly;
connecting a base to the power leads; and
securing an envelope to the subassembly to distribute light from the LED emitter.

23. The assembly method of claim 22, further comprising providing a plurality of different envelope styles, and selecting one of the plurality of different envelope styles to secure to the subassembly.

24. The assembly method of claim 22, further comprising providing a plurality of different base styles, and selecting one of the plurality of different base styles to connect to the power leads.

25. The assembly method of claim 22, further comprising providing a plurality of different candle tube styles, and selecting one of the plurality of different candle tube styles to install the LED lighting assembly into.
